(19) United States
(12) Patent Application Publication
(10) Pub. No.: US 2022/0409997 A1
(43) Pub. Date: Dec. 29, 2022

(54) AUTOMATED TOURNAMENTS

(71) Applicant: Sony Interactive Entertainment Inc., Tokyo (JP)

(72) Inventors: Adrian Harris, San Mateo, CA (US); Christopher Thielbar, San Francisco, CA (US); Derek Parker, San Mateo, CA (US); Yuji Tsuchikawa, San Francisco, CA (US)

(21) Appl. No.: 17/362,416

(22) Filed: Jun. 29, 2021

(51) Int. Cl. A63F 13/352; A63F 13/798

(52) U.S. Cl. CPC A63F 13/352; A63F 13/798; A63F 2300/513; A63F 2300/5566

(57) ABSTRACT

The present disclosure describes methods and systems directed towards automating tournaments within a gaming environment. Data regarding a first set of players that registered for a tournament may be received by a tournament server. The players are placed in a tournament queue. If the number of players in the tournament queue exceeds a certain threshold, then one or more tournaments are created based on a model tournament, the maximum size of the tournament, and the number of players in the tournament queue. The players in the tournament queue are placed into each of the tournaments that includes one or more matches

### BACKGROUND OF THE INVENTION

### 1. Technical Field

The present invention generally relates to management of game tournaments in digital gaming networks. More specifically, the present invention relates to automated management of game tournaments in digital gaming networks.

### 2. Description of the Related Art

There are presently many different varieties of online games played in a variety of different modes. Players operating player devices may access and participate in gameplay sessions hosted or managed by one or more servers that communicate using communication networks. Some online games are played head-to-head against one or more players, while others are played in teams (which may or may not compete against another team). The ability to support competition against other players and/or teams lends a game title to tournament-style play. Running such a tournament for online games may involve setting up, identifying qualified players, ranking or seeding players, bracketing or matching each round, scheduling competitions, resolving disputes, broadcasting the tournament competitions, results verification, and timely communication of tournament data.

Current online tournaments may be run by end-users or entities whose systems may not be integrated into the game as hosted by a gaming server in the gaming network. Such tournament systems may therefore lack real-time visibility and insight into in-game and tournament activities (e.g., as characterized by associated metadata). Such online tournaments may therefore experience significant technical barriers to entry, as well as face problems in implementation and scaling for large numbers of player devices, spectator devices (including commentator and curator devices), and streams. Such problems may lessen enjoyment and other benefits not only for the players, but also for spectators, commentators and other streamers, developers, sponsors, etc. As a result, tournaments may tend to be limited to those run by third parties for popular titles having numerous expert players. Such tournaments may exclude or at least be discouraging to novice players, as well as fail to support less popular game titles. There are presently no tools that might automate and otherwise facilitate management of online tournaments, nor are there any tools that may assist amateur tournament operators to attract, retain, and encourage repeat tournament players. Some of the present barriers of tournament gameplay is related to accessibility, convenience, and scale.

There is therefore a need for improved systems and methods that facilitate and streamline tournament management, registration, check-in, measurement of success and progress, stream distribution, and spectator support.

### SUMMARY OF THE CLAIMED INVENTION

Embodiments of the present invention include systems and methods for automating online tournament management. A plurality of computing devices may be used by a plurality of players to register for an online tournament. A tournament server that receives a first set of players registered for the tournament may place the first set of players in a tournament queue. The tournament server may then determine that the players in the tournament queue exceed a predetermined maximum tournament size. The tournament server may then create one or more tournaments based on a model tournament, the players in the tournament queue, and the predetermined maximum tournament size. The tournament server further places the players in the tournament queue into each of the tournaments.

### BRIEF DESCRIPTION OF THE DRAWINGS

FIG. 1 illustrates an exemplary network embodiment in which a system for automating tournaments may be implemented.

FIG. 2 illustrates an exemplary implementation of automated tournaments by the gaming network of FIG. 1.

FIG. 3 is a flowchart illustrating an exemplary method for automating tournaments.

FIG. 4 is a block diagram of an exemplary computing device that may be used to implement an embodiment of the system of FIG. 1.

### DETAILED DESCRIPTION

Embodiments of the present invention include systems and methods for automating online tournament management. A plurality of computing devices may be used by a plurality of players to register for an online tournament. A tournament server that receives a first set of players registered for the tournament may place the first set of players in a tournament queue. The tournament server may then determine that the players in the tournament queue exceed a predetermined maximum tournament size. The tournament server may then create one or more tournaments based on a model tournament, the players in the tournament queue, and the predetermined maximum tournament size. The tournament server further places the players in the tournament queue into each of the tournaments.

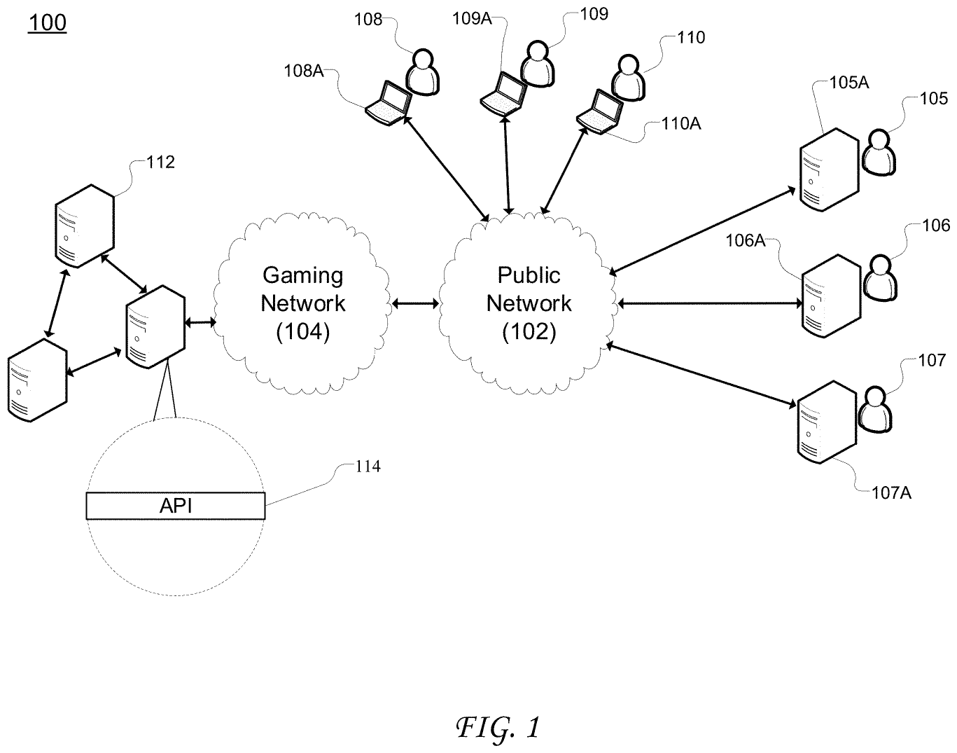

FIG. 1 illustrates an exemplary network environment 100 in which a system for automating tournaments may be implemented. Network environment 100 may include public network 102, gaming network 104, tournament server(s) 112 associated with application programming interface (API) 114, and user devices 105A-110A associated with users 105-110.

Public network 102 can include one or more private networks, such as, a local area network (LAN), a wide area network (WAN), or a network of public/private networks, such as the Internet. Public network 102 is communicatively coupled to gaming network 104 that represents a network of computing resources.

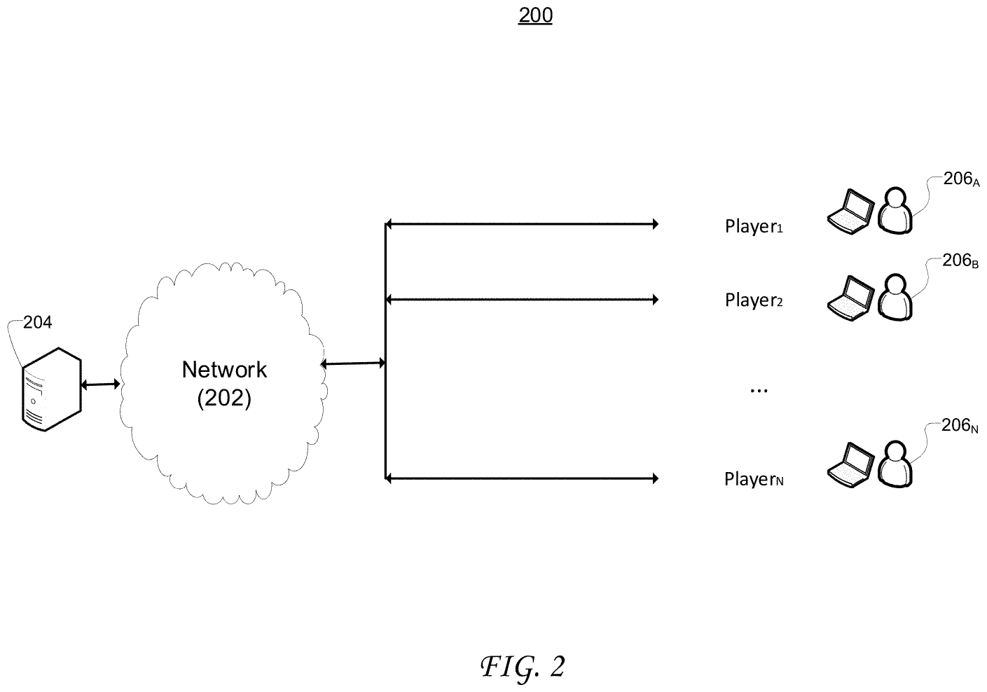

Gaming network 104 may be any collection of one or more servers configured to host and support one or more game titles accessible over public network 102. Discussed in more detail with respect to FIG. 2, a gaming network server of gaming network 104 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server. Together with public network 102, gaming network 104 may provide players and developers (via their respective devices) communicative access to tournament server 112.

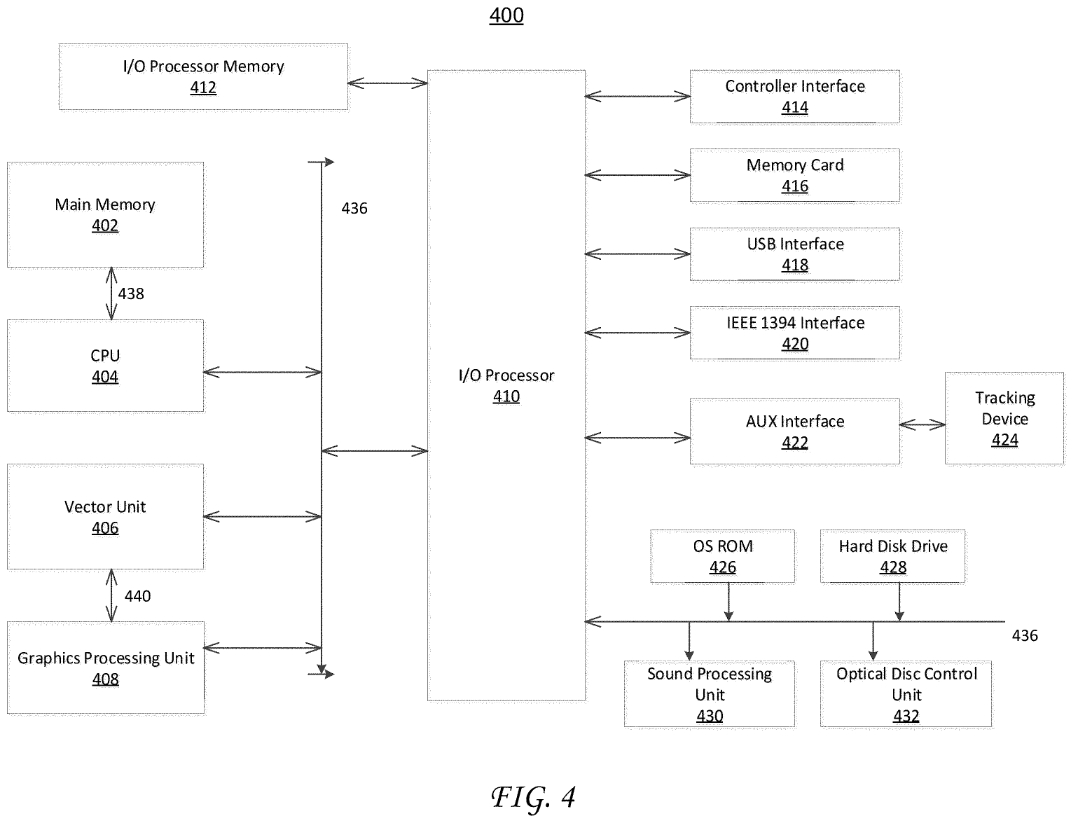

Players 108, 109, and 110 may participate in the automated tournaments on their respective computing devices 108A, 109A, and 110A. As illustrated, players 108, 109, and 110 are permitted access to tournament server 112 using respective computing devices (e.g., 108A, 109A, and 110A). As used herein, players 108-110 may be inclusive of spectators (and commentators) that may access a gameplay session or stream for the purpose of viewing rather than participation. Although computing devices 108A, 109A, and 110A are depicted as personal computing devices, it is understood that the computing devices can include various types of processor-based systems, including but not limited to: laptops, game consoles, smart phones, tablet computer systems, and the like. Example of hardware systems that can be used to implement the computing device are discussed in further detail below with respect to FIG. 4. Similarly, tournament operators (e.g., 105, 106 and 107), are permitted access to tournament server 112 via respective their computing systems (e.g., 105A, 106A, and 107A). It is understood that a greater (or fewer) number of players and/or developers can be engaged with gaming environment 100, without departing from the scope of the technology.

In practice, tournament server 112 is configured to create and support tournament-style competitions between various players and for multiple different game titles in accordance with specified and/or customized parameters. For example, tournament server 112 may facilitate player competition across multiple different game genres, such as real-time strategy (RTS) games, adventure games, puzzle games, and the like. A tournament operator may select any of the variety of different available game titles as bases for a custom tournament from a menu or other graphic interface provided by tournament server 112. Further, because the metrics that are used to evaluate player gameplay performance can vary widely between game title and type/genre, the tournament operator may be presented with options from the selected game titles, as well as options for defining custom metrics or game-performance attributes to be used to evaluate player performance for the tournament. For the tournaments, the tournament operators may define the tournament parameters and scheduling. In some embodiments, each tournament is created based on a template of a model tournament. The model tournament is the ideal size for a tournament to maximize the user experience based on difficulty and duration of the tournament.

By way of example, tournament operators 105, 106, and/or 107 can be developers of different game titles, users, or other entities, each of which is associated with a respective computing device used to communicate with tournament server 112. To facilitate tournament creation and management, each of the tournament operators can be prompted to submit game-performance attributes (e.g., selected from predetermined options or defined by customized metric definitions) to the tournament server 112, e.g., using respective computing systems 105A, 106A, and 107A. In a similar manner, the creation of gaming tournaments and corresponding tournament parameters can be managed at the player level, for example, by one or more of players 108, 109, and/or 110. That is, individual players or player collectives can provide specific game-performance attributes that they would like implemented to structure their own customized tournament play.

Although game-performance attributes can include virtually any type of information that can be used in conjunction with the creation, execution, management, and/or promotion of an online gaming tournament, in some aspects, game-performance attribute information can include game characteristics, including but not limited to one or more of: a “match type,” “event information,” and/or a player access list, etc. Game attributes information can also include game statistics, including but not limited to “high-level” player statistics such as: win/loss records, play time duration, levels achieved, points scored, and/or an ELO rating, etc. In some aspects, game statistics include “low-level” player statistics, including but not limited to: map-position information, map-path information, shots fired, time with rifle, time in kneel, time running, time to first fix, time to acquire a target, (e.g., “quick-draw” metrics), and/or measures of player/avatar health, etc.

The game-performance attributes, including game characteristics and game-play statistics can be received and recorded by tournament server 112, for example, using an application programming interface (API), such as API 114. In a similar manner, game-play statistics can be collected by API 114. The API 114 is also used by the tournament server 112 to publish the tournaments and the schedules set for tournaments. The published tournaments and schedules are published to the players and can be viewed on the players' respective computing devices 108A, 109A, and 110A. Inputs received via the API 114, may need to be validated.

Using the selections regarding game title(s) and received game attributes, the tournament server 112 may generate a custom tournament structure with parameters for automatically qualifying, registering, and seeding players, as well as scheduling matches and managing associated streams associated with specific matches within the custom tournament structure. Scheduled tournaments may have various statuses or phases. For example, a scheduled tournament may be labeled as “scheduled,” “open,” “check-in,” or “closed.” After the “check-in” phase, the tournament has “closed.” The “on-going” phase of the tournament begins once the tournament has “closed.” Furthermore, active or live tournaments may have various statuses or phases. An active or live tournament can be labeled as “on-going” or “ended.”

During the active or live tournament phase, tournament server 112 may create tournaments in response to certain triggers. For example, one or more tournaments may be created in order to accommodate a number of players registered for the tournament that exceed a predetermined tournament queue size. While the tournament is active or live, players may register for the next round of the tournament and be placed in the tournament queue.

Once the tournament begins, one or more matches may take place. For example, a tournament may have three matches in an initial round. After each match, the results are finalized, and a next round or bracket of matches may be generated based on the results. The process may continue until the rounds of the tournament are completed. Each match may run a clock that gives the players a certain allotted time to join the match. Once the clock runs out, gameplay may begin among the players that have joined the match.

Depending on implementation, game-play statistics can be collected via active monitoring of an online game environment, reported by the player devices 108A=110A, or received from one or more tournament or game server systems as part of a game performance data set that includes information describing individual player performance for one or more game titles and/or genre categories.

Generally, the tournament server 112 initiates, runs, and manages the automated tournaments. In doing so, the tournament server 112 may obtain gameplay data regarding the automated tournaments for the purpose of distributing that information in conjunction with streams of the tournament matches to remote spectators via their computing devices 108A, 109A, and 110A.

The tournament server 112 may also be capable of obtaining information related to the matches the players are participating in during the automated tournament. For example, microphones, cameras, and/or sensors of the player devices 108A-110A may be used to capture information regarding players 108-110. Information regarding the specific gameplay session (e.g., in-game environment, in-game interactions, gameplay metadata) of each match may be obtained from one or more servers of gaming network 104. The tournament server 112 can store the information obtained from the matches in a database. The database may be used to store the video data, as well as any gameplay information obtained.

A tournament creation request may involve one or more game titles available through a gaming network 104 associated with the tournament server 112. The tournament creation request may further specify a variety of parameters for qualifying, ranking, slotting, and scheduling the participants in the live e-sport event. A player having a user account (or team having a team account) may register and have their data automatically shared with the tournament server 112 for use in facilitating registration, rankings, promotions, awards, searches, and other tournament-related activities associated with the live e-sport tournament. The tournament request may further define or select a ranking system, which may include any combination of gameplay metrics used to evaluate each registrant in a standardized way.

In some aspects, tournament server 112 may use the parameters specified by the tournament creation request to rank registered players based on game data over a specified qualifying time period (e.g., the last or next 2 months of play), for a predetermined number of game plays (e.g., for 100 plays of a particular title), or for a “best-of” selection, e.g., by selecting the 3 best games played, or 5 best games out of 10, etc. For example, a predetermined time period may be specified as the qualifying time period in which players' gameplay data may be monitored and used for rankings. Once competition has concluded for the qualifying time period, tournament server 112 can use the game performance attributes and game-play statistics to determine a ranking based on skill level for each registered player. Determinations of skill level can vary depending upon the specified game performance attributes, and can vary between game titles and/or game genres. By way of example, skill level for a given player can be based on one or more of: collected points, a number of wins/losses, total game time, achieve difficulty level, and/or a number of “kills,” etc.

At the conclusion of qualifying competition, designations of achievement can be provided based on the overall ranking of a player or group of players. For example, digital trophies or medals can be provided to the top-ranked player (or player team), and published on an associated player (or team) profile. By publishing player (or team) accomplishments, competition can be encouraged amongst users of the online gaming environment, either on a game-by-game basis, a season-by-season basis, or across various game titles and genres. The digital trophies may be displayed next to a player's name on the bracket during a tournament.

In some aspects, players in a given tournament can be ranked into multiple categories or “tiers.” By way of example, a “platinum” tier may be designated for the top 2% of players, a “gold” tier designated for the subsequent 20% of players, a “silver” tier designated for the next 28% of players, and a “bronze” tier designated for the last 32%, etc. Subsequent to the conclusion of tournament play, players may be either promoted (to a higher tier), or demoted. By way of example, the top 10% of players in a tier may be moved up in tier ranking, e.g., from bronze to silver, and the bottom 10% in the tier may be moved down, e.g., from gold to silver tier. The category or tier of a particular player may be displayed next to the player's name on the bracket during a tournament.

FIG. 2 illustrates an exemplary implementation of automated tournaments by the gaming network of FIG. 1. Network architecture 200 includes tournament server 204 that is configured to receive gameplay information resulting from player engagement with the automated tournaments, e.g., via network 202 (which may be inclusive of public network 102 and gaming network 104). In the example illustrated in FIG. 2, each of the players (e.g., Playersl-N) can be engaged with a tournament.

Player performance information with respect to each tournament (for each player) can be recorded, (e.g., by tournament server 112 as discussed above). The player performance information may be used to determine relative player rankings.

Tournament server 204 is configured to receive the results reported by network 202. Depending on type and genre, the game title may be structured so that player performance in the tournament for any game title provides one or more types of results. The game title may further be structured to have a defined time limit to report a result associated with the tournament. In some examples, the result may be a score. In other examples, the result may be a win or a loss. Other metrics and results that may be reported to the tournament server 204 may include a reported status of cancellations or instances where there is an incomplete match.

Tournament server 204 is further configured to schedule tournaments. In some examples, the tournament server 204 selects a start time and a start date for the tournament. The tournament server 204 may further publish the tournament for specific regions. In other examples, the tournament server 204 may select hours between tournaments. The tournament server 204 may further select the tournament to repeat on select days or select weeks or selects hours in a particular day.

The tournament data, matches, and streams may be accessed and displayed via a client interface of the client computing devices 206A-N. A control center or game hub is provided on the client interface for the game titles. The tournament may be available as an action card in the control center or game hub. The action card may describe the structure and rules of the tournament, the approximate time commitment, the start time, the tournament mode, and the number of other players participating. A player may use their computing device 206 to select the action card to expand it, which provides additional information on the tournament and the option to register for the tournament.

Once the player has registered for the tournament, the action card may be expanded to show the option to join the match. Once the player selects the option to join a match, the player may either check-in to the match or allow a countdown to start. At the end of the countdown, the players are seeded (e.g., according to ranking) into the tournament and will receive a link to their first match in the tournament. In some examples, if the player does not select to join the match—which gives them an option or check-in or start a countdown—the player may be eliminated from the tournament.

Once the tournament begins and the first match concludes, a bracket may be displayed to show the player's progress through one or more rounds of the tournament. In some examples, the bracket may default to the player's current position. The bracket may display all players along with the respective contextual information of each player. The contextual information may include social relationships, streaming status, live results, and score in the matches the player has completed up to that point.

In some examples, the players in the tournament may receive notifications. Notifications may prompt the player to take particular steps, such as check in, join a match, or join the next match. Notifications may also notify the player of an award or their final placement in the tournament.

There are many variations and customizations that may be made to the structure and rules of the automated tournaments. For example, a tournament parameter may specify one or more entity types that may be entered into the tournament, such as individuals or teams. Different match formats may be selected for the tournament, including a series, a final score, or a final ranking. For example, if the selected match format is a final score, the game outputs a score (which may decide a winner), or the game may output multiple scores (which is summed to decide a winner). Furthermore, the tournament can be of various tournament modes. Examples of tournament modes include single-elimination, battle royale, 1vX, or Swiss.

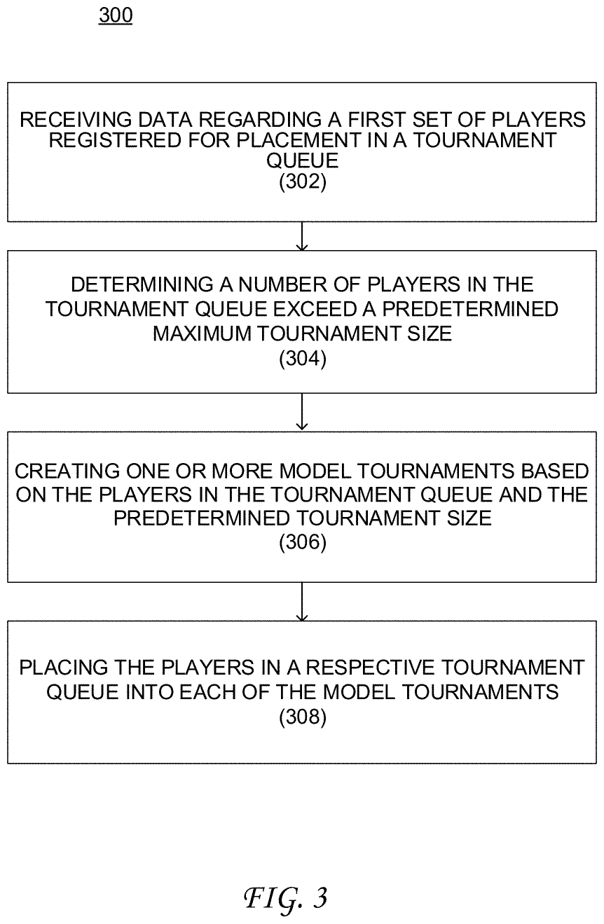

FIG. 3 is a flowchart illustrating an exemplary method for automating tournaments. Method 300 begins with step 302, where data regarding a plurality of players registered for a new automated tournament is received by the tournament server. The players are put in a tournament queue. At step 304, it may be determined that the number of players in the tournament queue exceed a predetermined maximum tournament size set by a tournament operator. In some examples, the tournament operator may be the developer of the game title. At step 306, one or more tournaments are created with similar parameters to facilitate the players in the tournament queue.

At step 308, the players in the tournament queue are divided into the tournaments. The tournaments have similar parameters, which are set ahead of time. The parameters may be set by the tournament operator. The tournament parameters may include how much time there is to check-in, the estimated time per match, how often the tournament is available, and the length of the tournament. The tournament parameters may further include modes of competition, tournament format, and countries or regions that the players are located. Thus, as the rounds of the tournament are started and completed, tournament server 112 may use such parameters to automatically manage and perform tournament operations without requiring further input from the tournament operator. Further, the streams associated with each of the tournaments may be made available to spectators and other users through interfaces displayed in accordance with the specified parameters as well.

FIG. 4 is a computing device used in context of the system of FIG. 1. The computing device 400 may include various elements as illustrated in FIG. 4. It should be noted that the elements are exemplary and that other embodiments may incorporate more or less than the elements illustrated. The computing device 400 (e.g., desktop, laptop, tablet, mobile device, console gaming system) is a device that the user can utilize to facilitate carrying out features of the present invention pertaining to creating winner tournaments with fandom influence. The computing device 400 would also facilitate the user viewing of the tournament data via a display associated with the computing device 400.

With reference to FIG. 4, the computing device 400 includes a main memory 402, a central processing unit (CPU) 404, at least one vector unit 406, a graphics processing unit 408, an input/output (I/O) processor 410, an I/O processor memory 412, a controller interface 414, a memory card 416, a universal serial bus (USB) interface 418, and an IEEE 1394 interface 420, an auxiliary (AUX) interface 422 for connecting a tracking device 424, although other bus standards and interfaces may be utilized. The computing device 400 further includes an operating system read-only memory (OS ROM) 426, a sound processing unit 428, an optical disc control unit 430, and a hard disc drive 432, which are connected via a bus 434 to the I/O processor 410. The computing device 400 further includes at least one tracking device 424.

The tracking device 424 may be a camera, which includes eye-tracking capabilities. The camera may be integrated into or attached as a peripheral device to computing device 400. In typical eye-tracking devices, infrared non-collimated light is reflected from the eye and sensed by a camera or optical sensor. The information is then analyzed to extract eye rotation from changes in reflections. Camera-based trackers focus on one or both eyes and record their movement as the viewer looks at some type of stimulus. Camera-based eye trackers use the center of the pupil and light to create corneal reflections (CRs). The vector between the pupil center and the CR can be used to compute the point of regard on surface or the gaze direction. A simple calibration procedure of the viewer is usually needed before using the eye tracker.

Alternatively, more sensitive trackers use reflections from the front of the cornea and that back of the lens of the eye as features to track over time. Even more sensitive trackers image features from inside the eye, including retinal blood vessels, and follow these features as the eye rotates.

Most eye tracking devices use a sampling rate of at least 30 Hz, although 50/60 Hz is most common. Some tracking devises run as high as 1250 Hz, which is needed to capture detail of very rapid eye movement.

A range camera may instead be used with the present invention to capture gestures made by the user and is capable of facial recognition. A range camera is typically used to capture and interpret specific gestures, which allows a hands-free control of an entertainment system. This technology may use an infrared projector, a camera, a depth sensor, and a microchip to track the movement of objects and individuals in three dimensions. This computing device may also employ a variant of image-based three-dimensional reconstruction.

The tracking device 424 may include a microphone integrated into or attached as a peripheral device to computing device 400 that captures voice data. The microphone may conduct acoustic source localization and/or ambient noise suppression.

Alternatively, tracking device 424 may be the controller of the computing device 400. The controller may use a combination of built-in accelerometers and infrared detection to sense its position in 3D space when pointed at the LEDs in a sensor nearby, attached to, or integrated into the console of the entertainment system. This design allows users to control functionalities of the computing device 400 with physical gestures as well as button-presses. The controller connects to the computing device 400 using wireless technology that allows data exchange over short distances (e.g., 30 feet). The controller may additionally include a “rumble” feature (i.e., a shaking of the controller during certain points in the game) and/or an internal speaker.

The controller may additionally or alternatively be designed to capture biometric readings using sensors in the remote to record data including, for example, skin moisture, heart rhythm, and muscle movement.

As noted above, the computing device 400 may be an electronic gaming console. Alternatively, the computing device 400 may be implemented as a general-purpose computer, a set-top box, or a hand-held gaming device. Further, similar user devices may contain more or less operating components.

CPU 404, vector unit 406, graphics processing unit 408, and I/O processor 410 communicate via system bus 436. Further, the CPU 404 communicates with the main memory 402 via a dedicated bus 438, while the vector unit 406 and the graphics processing unit 408 may communicate through a dedicated bus 440. The CPU 404 executes programs stored in the OS ROM 426 and the main memory 402. The main memory 402 may contain pre-stored programs and programs transferred through the I/O Processor 410 from a CD-ROM, DVD-ROM, or other optical disc (not shown) using the optical disc control unit 432. The I/O processor 410 primarily controls data exchanges between the various devices of the computing device 400 including the CPU 404, the vector unit 406, the graphics processing unit 408, and the controller interface 414.

The graphics processing unit 408 executes graphics instructions received from the CPU 404 and the vector unit 406 to produce images for display on a display device (not shown). For example, the vector unit 406 may transform objects from three-dimensional coordinates to two-dimensional coordinates, and send the two-dimensional coordinates to the graphics processing unit 408. Furthermore, the sound processing unit 430 executes instructions to produce sound signals that are outputted to an audio device such as speakers (not shown).

A user of the computing device 400 provides instructions via the controller interface 414 to the CPU 404. For example, the user may instruct the CPU 404 to store certain information on the memory card 416 or instruct the computing device 400 to perform some specified action. Example controllers associated with the controller interface 414 may include a touch-screen, keyboards and game controllers.

Other devices may be connected to the computing device 400 via the USB interface 418, the IEEE 1394 interface 420, and the AUX interface 422. Specifically, a tracking device 424, including a camera or a sensor may be connected to the computing device 400 via the AUX interface 422, while a controller may be connected via the USB interface 418. In some embodiments, a VR headset or related hardware equipment may be communicatively coupled to computing device 400 via one or more computing interfaces. Hardware and related software for implementing an augmented reality (AR) experience may similarly be coupled to computing device 400 via on or more computing interfaces.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A system for automating tournaments, the system comprising:
one or more gaming network servers associated with one or more game titles; and
a tournament server that:
receives data regarding a first set of players registered for a tournament, wherein the first set of players are placed in a tournament queue;
determines that a number of the players in the tournament queue exceed a predetermined maximum tournament size, wherein the predetermined maximum tournament size is set by a tournament operator;
receives one or more customized tournament parameters from the tournament operator, wherein the one or more customized tournament parameters include custom metrics to evaluate player performance;
creates one or more tournaments based on a model tournament and the customized tournament parameters, the number of the players in the tournament queue, and the predetermined maximum tournament size, wherein each of the tournaments include one or more matches; and
places the players in a respective tournament queue in each of the tournaments.

2. The system of claim 1, wherein the tournament server automatically repeats the one or more tournaments after a predetermined time, wherein the predetermined time is determined by the tournament operator.

3. The system of claim 1, wherein the tournament server reports a result of each of the tournaments based on gameplay data from the one or more matches.

4. The system of claim 1, wherein the tournament server receives data regarding a second set of players registered for placement in the tournament queue.

5. The system of claim 4, wherein the second set of players are registered while the tournament is active.

6. The system of claim 1, wherein the one or more tournaments have one or more parameters in common.

7. The system of claim 6, wherein the parameters include a region where the players are located.

8. The system of claim 1, wherein the tournament server further presents one or more options for customizing tournament parameters to the tournament operator.

9. A method for automating tournaments, the method comprising:
receiving data regarding a first set of players registered for a tournament, wherein the first set of players are placed in a tournament queue;
determining that a number of the players in the tournament queue exceed a predetermined maximum tournament size, wherein the predetermined maximum tournament size is set by a tournament operator;
receiving one or more customized tournament parameters from the tournament operator, wherein the one or more customized tournament parameters include custom metrics to evaluate player performance;
creating one or more tournaments based on a model tournament and the customized tournament parameters based on a model tournament, the number of the players in the tournament queue, and the predetermined maximum tournament size, wherein each of the tournaments include one or more matches; and
placing the players in a respective tournament queue in each of the tournaments.

10. The method of claim 9, further comprising:
automatically repeating the one or more tournaments after a predetermined time, wherein the predetermined time is determined by the tournament operator.

11. The method of claim 9, further comprising:
reporting a result of each of the tournaments based on gameplay data from the one or more matches.

12. The method of claim 9, further comprising:
receiving data regarding a second set of players registered for placement in the tournament queue.

13. The method of claim 12, wherein the second set of players are registered while the tournament is active.

14. The method of claim 9, wherein the one or more tournaments have one or more parameters in common, wherein the parameters include a region where the players are located.

15. The method of claim 9, further comprising presenting one or more options for customizing tournament parameters to the tournament operator.

16. A non-transitory computer-readable storage medium, having embodied thereon a program executable by a processor to perform a method for automating tournaments, the method comprising:
receiving data regarding a first set of players registered for a tournament, wherein the first set of players are placed in a tournament queue;
determining that a number of the players in the tournament queue exceed a predetermined maximum tournament size, wherein the predetermined maximum tournament size is set by a tournament operator;
receiving one or more customized tournament parameters from the tournament operator, wherein the one or more customized tournament parameters include custom metrics to evaluate player performance;
creating one or more tournaments based on a model tournament and the customized tournament parameters based on a model tournament, the number of the players in the tournament queue, and the predetermined maximum tournament size, wherein each of the tournaments include one or more matches; and
placing the players in a respective tournament queue in each of the tournaments.

17. The non-transitory computer-readable storage medium of claim 16, further comprising instructions to cause the processors to perform operations for:
automatically repeating the one or more tournaments after a predetermined time, wherein the predetermined time is determined by the tournament operator.

18. The non-transitory computer-readable storage medium of claim 16, further comprising instructions to cause the processors to perform operations for:
reporting a result of each of the tournaments based on gameplay data from the one or more matches.

19. The non-transitory computer-readable storage medium of claim 16, further comprising instructions to cause the processors to perform operations for receiving data regarding a second set of players registered for placement in the tournament queue.

20. The non-transitory computer-readable storage medium of claim 16, wherein the one or more tournaments have one or more parameters in common, wherein the parameters include a region where the players are located.
